(19) United States
(12) Patent Application Publication
(10) Pub. No.: US 2024/0425128 A1
(43) Pub. Date: Dec. 26, 2024

(54) BED, RACK AND MODULAR COMPONENTS FOR VEHICLES SYSTEMS

(71) Applicants: Eddie Dorszynski, San Diego, CA (US); Harrison McCarey, San Diego, CA (US); Brandon Wood-Fisher, Madrid, IA (US); Taylor Dorszynski, San Diego, CA (US)

(72) Inventors: Eddie Dorszynski, San Diego, CA (US); Harrison McCarey, San Diego, CA (US); Brandon Wood-Fisher, Madrid, IA (US); Taylor Dorszynski, San Diego, CA (US)

(21) Appl. No.: 18/736,397

(22) Filed: Jun. 6, 2024

Related U.S. Application Data
(60) Provisional application No. 63/471,494, filed on Jun. 6, 2023.

(51) Int. Cl. B62D 63/02; B60N 3/00; B60R 7/04; B60R 13/08; B60R 16/02; B62D 25/06; G06Q 30/0601

(52) U.S. Cl. CPC B62D 63/025; B60N 3/001; B60N 3/008; B60R 7/04; B60R 13/08; B60R 16/0207; B62D 25/06; G06Q 30/0601

(57) ABSTRACT

A bed, rack and modular components for vehicles system including: framing, surface members, a plurality of fasteners, electrical harnesses and components, and insulation, wherein a first-portion of the framing is affixed to an interior of a vehicle via the plurality of fasteners and is in mechanical communication with a second-portion of the framing which is affixed in combination with the surface members into a bed, and racks that are able to be modularly oriented as per user-preference. The kit is able to be purchased and shipped via flat pack and ship means.

### CROSS-REFERENCE TO RELATED APPLICATION

The present application is related to and claims priority from prior provisional application Ser. No. 63/471,494, filed Jun. 6, 2023 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of vehicles and more specifically relates to vehicle retrofitting.

### 2. Description of the Related Art

In modern society vehicles are designed to transport persons and items. There are many types of vehicles for many uses. Often vehicles are constrained in their effective functional use according to the type of vehicle used. Vans may be used to transport a sufficient amount of payload for local deliveries or may be used for camping or multi day road travel. Vans may be used to transport and deliver goods from companies such as Amazon. Vans may also be used for work by trades persons. Often vans come in camperized or ‘empty box’ versions and are not conventionally equipped for specialized use. This may not suit all customers to their specific needs. A suitable solution is desired.

Various attempts have been made to solve the above-mentioned problems such as those found in U.S. Pub. No. 2019/0351805 to Derek M. May. This art is representative of modular systems. None of the above inventions and patents, taken either singly or in combination, is seen to describe the invention as claimed.

Ideally, a vehicle retrofitting system should provide efficiency in specific use and, yet would operate reliably and be manufactured at a modest expense. Thus, a need exists for a reliable bed, rack and modular components for vehicles systems to avoid the above-mentioned problems.

### BRIEF SUMMARY OF THE INVENTION

In view of the foregoing disadvantages inherent in the known vehicle retrofitting art, the present invention provides a novel bed, rack and modular components for vehicles system. The general purpose of the present invention, which will be described subsequently in greater detail is to provide an efficient and effective means to make use of vehicles for multi-functional use via modular means.

A bed, rack and modular components for vehicles system is disclosed herein comprising: framing, surface members (wood, composite, laminate or the like), a plurality of fasteners, electrical harnesses and components, and insulation, wherein a first-portion of the framing is affixed to an interior of a vehicle via the plurality of fasteners and is in mechanical communication with a second-portion of the framing which is affixed in combination with the surface members (wood for example) into a bed, and racks that are able to be modularly oriented as per user-preference. The present invention should be considered to encompass multiple furniture items that may be modularly installed and uninstalled in a variety of configurations. Beds, chairs, cabinets, desks, shelves, toilet enclosures, kitchen appliances and enclosures, couches and the like.

The second-portion of the framing is able to be manipulated in relation to the first-portion of the framing at will. The electrical harnesses and the components are in electrical communication with the vehicle to service electrical devices in the interior of the vehicle. The insulation is a sound deadener.

The product is as follows: Workbench PN: 1007 (passenger's side) & PN: 1008 (driver's side). The complete package in certain embodiments comprises a workbench four Panel System which is made up of preferably two sub-assembly packages—the workbenches and the mounting kits (PN: 1011). Both assemblies are composed of two panels in preferred embodiments. Each kit is precisely cut, drilled and precision machined of preferably extruded t-slot aluminum (rustproof, waterproof, and corrosion resistant) rails. The vast majority of mounting, connecting and related hardware(s) are made from high-quality stainless steel with similar corrosion resistant characteristics.

The present invention not only satisfies the need and desire for increased countertop space and work surface area demand desired in the current market, but also the multiple other innovative applications designed into this product drive a large amount of configuration opportunities. The work surfaces are engineered and designed to open and close by way of a ‘marriage’ of a quick-release pin that also serves as the hinge. This design also preferably incorporates a gas spring mounting that provides automatic effortless opening of the panels. They are also engineered to slide along the UHMW mount strip profile. Each panel individually is capable to being adjusted in reference to the height of the work surface panel while they are being installed providing added ease of use and comfort. Once the desired height is determined it can be secured in place by the quick-release pin and tightening the thumbscrew connected to the UHMW mount strip profile. The novelty in this aspect of the present invention also lies in its ability to be removed and utilized for many other various uses. The workbench is removed by pulling the quick release pin and removing the gas spring arm which then securely attaches to its own lock pin on the back of the panel. The workbench has excellent versatility and utility when combined with the bed and rack system. The workbenches can be used for relaxation and work surfaces at different heights simultaneously. Additionally, when removed, 3 of the workbenches can be used to make the fixed panel bed as well as the upper bunk bed/material rack by laying the benches across the width of the vehicle using the secure edge rail of each side of the vehicles. 1 to 2 workbenches panels can be used as a table (1-small 2-large).

The workbenches also modulate into various relaxation/recliners when used in conjunction with the bed flip-ups and the secure edge rail of each side of the bench to face either the front or the rear of the van. Additionally, the workbenches can be removed and stored out of the way in a lined cubby for an open concept and relaxed layout. Many options and configurations are available for use to suit customer-preference.

A kit is also disclosed herein for the bed, rack and modular components for vehicles system which includes: the framing comprising the first-portion of the framing comprising the floor section, the right-wall-section, the left-wall-section and the roof-section, and the second-portion of the framing, the surface members (wood or other material) cut to form the bed, the desk, the shelves and the doors, the plurality of fasteners, the hydraulic rams, the electrical harnesses and components, the insulation, and a set of installation instructions and video with information as to potential modular designs.

A method of monetizing a bed, rack and modular components for vehicles system is also described comprising the steps of: offering a modular bed, rack and modular components for vehicles system for purchase by at least one consumer, at least one consumer is able to custom select a user-defined package, receiving payment for the user-defined package, packaging the user defined package according to a pre-determined shipping rate for shipping (flat pack and ship, also described herein), and shipping the user defined package to the at least one consumer. The method may further comprise the step of licensing the installation to an installation-entity to install the bed, rack and modular components for vehicles system for at least one consumer.

A universalized mounting structure for vehicles system is also described herein, to assist in understanding the super structure for mounting of the various modular furniture items, comprising: framing, material, a plurality of fasteners, electrical harness(es) and components, and insulation; wherein the universalized mounting structure for vehicles system in functional combination is effective for use as installed in the vehicle and is sold as a kit for installation. The pre-fabricated harness and electrical wiring can be placed between the wall of the van body and the framing. The framing is used for mounting the surface members (wood) as a surface. The framing is affixed to the host vehicle permanently or may be removable after use. The framing may be fit to and adaptable between different dimensioned vehicles. The framing may also be adaptable to dimensional variations from vehicle to vehicle allowing consistency to be maintained in different retrofits. OEM holes are desirable mounting points for fasteners such as threaded inserts. The framing may take on various configurations such as for use in camping, working, trades tool hauling and the like. The exemplary means are not to be interpreted as limiting in any way. The framing may be installed in floor, wall and roof sections and is preferably installed in the respective manner; however alternative embodiments may be installed in other orders and in different orientations.

The framing of the universalized mounting structure for vehicles system preferably comprises non-ferrous material; the non-ferrous material used preferably comprises aluminum however other materials may be used. The aluminum is preferably extruded such as T-slot, and may be affixed to the interior of the host vehicle via any suitable means (fastened by mechanical means, adhesive means or the like such as threaded inserts or epoxy). In preferred embodiments the non-ferrous material is corrosion resistant. The framing is preferably of tubular construction. The framing comprises a side-wall, preferably one side-wall with four exterior sides; wherein the tubular construction is 3D-square in profile and comprises a length, the tubular construction able to hold at least a weight of 500 pounds.

The universalized mounting structure for vehicles system comprises bed frames, desk frames, seating frames, storage frames which are modular and form a portion of the framing. The modular capability enables the present invention to be removed and re-configured, modified, replaced and maintained as desired. The framing is affixed to the host vehicle and the surface members (wood or other material) is mounted thereto. Magnets may be used to hold the wall sections to the interior of the van on the walls. Other fastening means permanent or semi-permanent may be used. The wood for the surface members or other material may be milled to have a key for insertion into the T-slot framing. Extruded aluminum such as 80-20 may be used for rigidity. Twist locks may be used for fastening means for panels, accessories or the like. The 80-20 t slot may have a keyway or double keyway profile that is used to promote rigidity, options of fastening orientations.

The universalized mounting structure for vehicles system may comprise a kit as a trades-kit; a camperized-kit or a work-on-the-go kit conducive to a remote working and living lifestyle kit. The universalized mounting structure for vehicles system may be sold as kit comprising the following parts: the framing, the surface members (wood or other material suitable for surfaces), the plurality of fasteners, the electrical harnesses and the components, and the insulation; wherein the universalized mounting structure for vehicles system in functional combination is installable in the vehicle and is sold as the kit for installation for trades-purposed-vehicles, camperized-purposed-vehicles and multi-purpose work-on-the-road-vehicles.

The kit has instructions such that functional relationships are detailed in relation to the structure of the invention (such that the invention can be used, maintained, or the like in a preferred manner). The universalized mounting structure for vehicles system may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

A method of using a universalized mounting structure for vehicles system preferably comprises the steps of: providing the universalized mounting structure for vehicles system as a kit which has in its method, designing components for a system that are engineered, sized and weighted to maximize shipping cost-effectiveness, as packaged, to be ultimately delivered to at least one consumer, manufacturing the components, packaging the components, and shipping the components; wherein the universalized mounting structure for vehicles system is modular and retrofittable into a vehicle for multi-purpose use as per consumer-preference. Tools needed for the installation may be included, owned or rented.

A method for flat pack and shipping is also disclosed herein as a preferred method of cost-effective and efficient shipping comprising: designing components for a system that are specifically engineered, sized and weighted to maximize shipping cost-effectiveness, as packaged, to be ultimately delivered to at least one consumer, manufacturing the components, packaging the components, and shipping the components. For example with the present kit being disclosed the boards and framing are cut to specific length, width and weighed that with the remainder of the components come in at exactly the maximum shipping weight, length and depth to a delivery companies limits (eg. Amazon, DHL, Fedex®, USPS or UPS or other). An example is: using FedEx Express® U.S. services, a selling entity can ship packages up to 150 lbs.; up to 119″ in length and 165″ in length and girth with no upcharges (unless residential delivery). Other specifications for delivery may be used but the above has been provided for exemplary means to provide a reference for enablement. This takes into account that the shipping will be maximized cost-effectively allowing the selling entity to realize more profits, the consumer to realize greater value, and the shipping company to realize standardization in shipping from the selling entity.

The method for flat pack and shipping may be used in different scenarios for example the at least one consumer may be a wholesaler; wherein the at least one consumer being the wholesaler may be licensed by an entity to sell the components. The components may comprise a kit; wherein the components of the kit may comprise surface members of wood (or other suitable equivalent) and non-ferrous items. Upon reading this specification, it should be appreciated that, under appropriate circumstances, considering such issues as user preferences, design preference, structural requirements, marketing preferences, cost, available materials, technological advances, etc., other kit arrangements and materials and non-kits may use the described method such as, for example, kits of different components, kits made of items with different materials than mentioned (but taken into account), etc., may be sufficient.

The method for flat pack and shipping may have the at least one consumer as a retailer wherein the at least one consumer being the retailer is licensed by an entity to sell the components. The components may or may not comprise a kit (non-kit). The efficiencies may be realized by engineering specifically the kits to fit in standardized boxes such that expenses for shipping are reduced. Fillers and packing will also be minimized. Unique shaped boxes may be used. Boxes (or other parcel packaging shipping means) can be selected as disclosed herein and may be within a range and kit sizes may change as per changes in kits as per changes in the vehicles.

The method for flat pack and shipping may have at least one consumer as an installer; wherein the installer is able to be licensed by an entity (preferably the selling entity) to install the components in a vehicle for the end-customer. The end-customer pays for the kit and has the installer (who has the licensing and training from the selling entity) install the product for use. The vehicle referred to herein generally comprises a van body. In certain product offerings the vehicle does not comprise a van body and may comprise a man-cave product or the like.

The method for flat pack and shipping also benefits and is useful to at least one consumer who is a do-it-yourselfer; wherein a kit is included for ease of DIY installation comprising easy to understand and follow instructions for installation. Generally, the method deals with selling the components in a kit, however it can be applied equally to non-kits.

In certain embodiments the kit includes: framing (such as extruded aluminum tubing for example or other ferrous or non-ferrous materials such as composites), surface members, a plurality of fasteners as needed for installation to affix it to the vehicle or other), and a set of the instructions. The kit may further include for example: electrical wiring, electrical components, control system, wiring harness, solar system components, hydraulic rams and the like.

The present invention holds significant improvements and serves as a bed, rack and modular components for vehicles. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bed, rack and modular components for vehicles system, constructed and operative according to the teachings of the present invention.

FIG. 1 shows a perspective view illustrating a bed, rack and modular components for vehicles system according to an embodiment of the present invention.

FIG. 2 is a perspective view illustrating the bed, rack and modular components for vehicles system according to an embodiment of the present invention of FIG. 1.

FIG. 3 is a perspective view illustrating the bed, rack and modular components for vehicles system according to an embodiment of the present invention of FIG. 1.

FIG. 4 is a perspective view illustrating the bed, rack and modular components for vehicles system according to an embodiment of the present invention of FIG. 1.

FIG. 5 is a flowchart illustrating a method of use for the bed, rack and modular components for vehicles system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a means to improve the functionality of vehicles for multi-purpose use and more particularly to a bed, rack and modular components for vehicles system as used to improve the efficiency of vehicle use.

Generally speaking, the complete package of the bed and rack system is made up of two sub-assembly packages. Both assemblies are preferably composed of precisely cut, drilled and precision machined extruded t-slot aluminum (corrosion resistant) rails (framing). The vast majority of mounting, connecting and related hardware(s) is made from high quality stainless steel with similar corrosion qualities. The seating bench is able to be converted into a bedding area by way of the SUGATSUME bed panel stays (high-quality stainless steel, Japanese engineered and manufactured are preferably used).

The surface members (wood or other) is precision cut and milled panels. Each panel is prepared and fitted as a 3D surface by which to set items on. Each part is visually inspected and measured for proper location and sizing of the specific application. The panels can be customized with for example pictures, maps, flags, decorations or the like. They can be engraved, etched or other. Reference numbers/designators may be etched on the components to make installation easier.

Another benefit of the bed and rack system is its ability to convert a very limited space (seating area—8 persons) quickly and securely into a true full-size queen bed area, as well as being able to use one side or the other for a variety of relaxation areas. When coupled with the adjustable and removable workbench invention, it can also be used for relaxation as well as work simultaneously for multiple people. Furthermore, the other components of the “bed and rack system” allow the user to add a considerable variation of sleep, work, storage, and relaxation areas in a very confined space because every product of the present invention should do multiple things. In addition to the articulating bed panel construction, the user can use the removable workbench panels to create the “Fixed Panel Bed”. Three out of the four removable workbench panels fit precisely on top of the very secure edge rail of each side of the bench that creates the fixed panel bed allowing the user the optionality to go with the conventional bed and “garage” configuration. Also, the user can access the areas (eight-four on each side) underneath the seats for storage by way of removable top loading seat surfaces. On top of the removable seat access panels, the customer will have choices of cushion sizes and types as well as fabric choices to better express their personal tastes. The cushion sizes and shapes have been designed and configured in such a way to allow the customer maximum flexibility to utilize the cushions for relaxation and comfort options.

The bed and rack system was invented, engineered, prototyped to achieve the ability to install a large selection of full queen size (80″×60″) bedding options from the most luxurious pillow top home mattress to a simple backpacking mat. The flexibility of this invention design is unique in the features as follows: the design of this product is mounted lengthwise inside the conversion van/vehicle facilitates using the minimum amount of structure space while allowing the maximum amount of usable payload space/free area, as opposed to the majority of conventional bed systems that are designed and installed widthwise (across the payload space); and many companies designing similar bed-related products (which every conversion must have) like to refer to this wasted payload or free space as “the garage”. In reality, it is a space that is difficult to access and very inefficient in overall space usage. Using the present invention every inch counts.

The above is mounted very securely to the super structure kit previously mentioned; the super structure mounted to the host van (or other vehicle). One of the requirements to utilize so many products and providing multiple features to each product is based on safely and securely mounting of the components to the structural integrity of the conversion van/vehicle by way of the super structure.

In certain embodiments there is the ability to use one to four of the removable workbench panels to create multiple different reclining/variable relaxation positions throughout the bed and rack system area. They may be used separately or in combination.

In addition when you combine the upper cabinet product and the adjustable removable workbench product as well as the mounting kit that facilitates installing both of the formers an additional bunkbed or upper storage/material rack can easily be created by way of placing the removable workbench panels on the engineered designed support rail of the upper cabinet assembly.

After many attempts at determining the precise measurements of the varying dimensions of the factory produced rear cargo area, the inventor(s) were able to create this extremely modular and flexible product line. Specifically, the reason the user can use the removable workbenches to create the fixed panel bed, as well as the upper bunk/storage/materials shelf, was by determining these exact variations and building the entire product line accordingly.

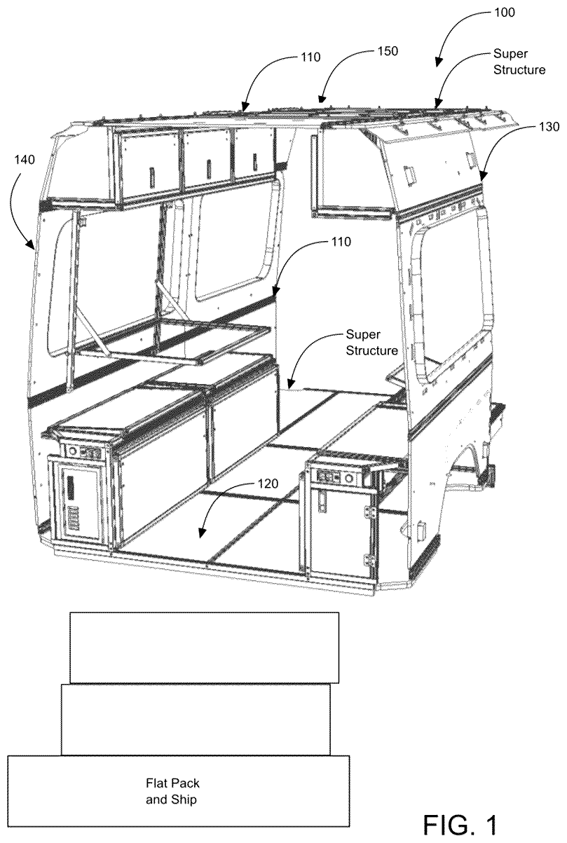

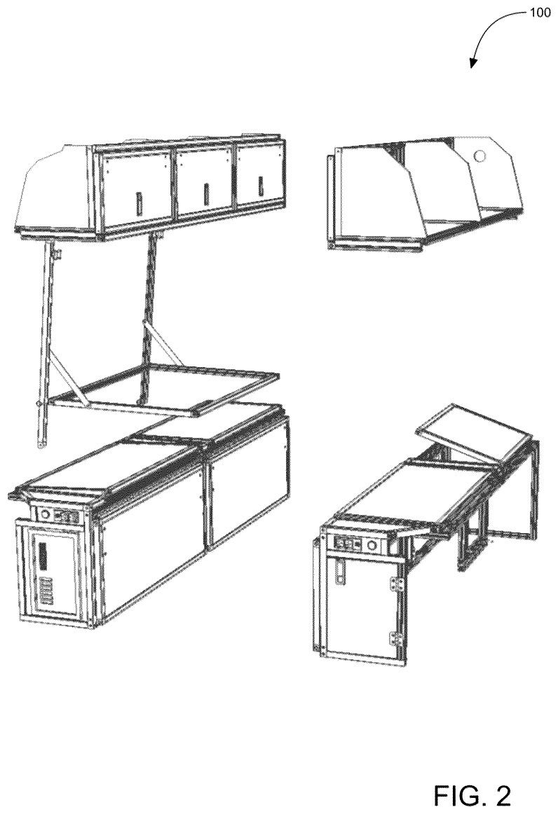

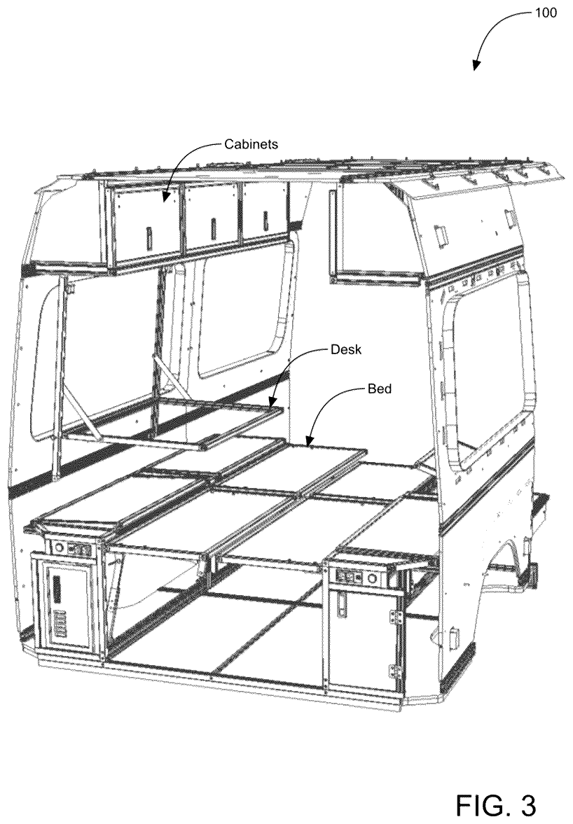

Referring to the drawings there is shown in FIGS. 1-4, various views of the bed, rack and modular components for vehicles system 100 comprising: framing 110, (surface members) (wood or other suitably durable material), a plurality of fasteners (fastening means mechanical or non-mechanical), electrical harnesses and components, and insulation. As designed a first-portion of the framing 110 is affixed to an interior of a vehicle via the plurality of fasteners and is in mechanical communication with a second-portion of the framing which is affixed in combination with the wood surface members into a bed, and racks that are able to be modularly oriented as per user-preference. The second-portion of the framing 110 is able to be manipulated in relation to the first-portion of the framing 110 at will. In certain embodiments spray on sound deadener may be used, in combination with thermo-insulation such as THINSULATE®.

The electrical harness(es) and the components are in electrical communication with the vehicle to service electrical devices in the interior of the vehicle, such as for example if the user wishes to plug in a computer for use at the desk, a television, lights, appliances or the like. Certain embodiments may use solar powering and other embodiments may use DC battery power. A combination of power sources may be used. The insulation is a sound-deadener and may be useful for providing resistance to heat transfer into and out of the vehicle.

The bed, rack and modular components for vehicles system 100 may further comprise hydraulic rams; wherein the hydraulic rams allow tables to be in communication with the first-portion of the framing 110. The hydraulic rams may be used to attach any number of different components suitable for functional use. Table(s) may be included and are able to be raised and alternately lowered in relation to the first-portion of the framing 110. In certain embodiments a table is provided which is able to be lowered in relation to a roof wall of the first-portion of the framing 110. The first-portion of the framing 110 of the bed, rack and modular components for vehicles system 100 may comprise a floor section 120, a right-wall-section 130, a left-wall-section 140 and a roof-section 150, all designed to be installed respectively. In certain embodiments right-wall-section 130, and left-wall-section 140 may be installed in a switched order. In certain embodiments the right-wall-section 130, and left-wall-section 140 may be mirror images of each other and in sliding door van installations the sections may be very different from each other. As designed, the floor-section 120, the right-wall-section 130, the left-wall-section 140 and the roof-section 150 are installable within and to the interior of the vehicle. The benches can have bed panels attached which rotate into position for use as a bed when desired. The bed panels are able to lock for use as a bed. Interchangeably they can be oriented for use as a sitting surface.

For camperized or partially-camperized van versions the bed may comprise exactly one bed; the bed horizontally oriented during in-use periods yet able to be removed and/or items able to be stored under the bed. The bed may be removed for storage of tools and desired items. The bed when removed creates a walkway in the van body. In other embodiments the bed comprises two or more of the beds; a top-bed oriented on a plane above a bottom-bed. The beds may be oriented such that the top-bed is directly above the bottom-bed as in a bunk-bed formation suitable for children on the top-bed. Headspace is able to be maximized in the present invention. Trade specific conversions kits may be sold such that various trades have effective holding, storing means for example with electrical trades there may be hangers for cable, shelves for conduit, drawers for connectors, holders for tools, and in a similar way the available space may be retro-fit for other trades such as plumbing, construction, mechanics, and the like. The above-mentioned trades are only provided for exemplary means and are not intended to be limiting in any way. Other non-trade versions are envisioned such as for surfers, music bands, and delivery vehicles for example. Delivery vehicle versions may use the electrical harnesses and components to facilitate tracking of parcels when removed for the van and other sensing means may be used.

Referring now to the racks; the racks are able to provide mounting for shelves; wherein the shelves may be open for ease of access to stored items and alternately the shelves are able to be closed via doors on hinges mounted thereon, and alternately opened and closed via rotating the doors. Doors are useful for creating cabinets for example for storing food or supplies. The racks are able to provide mounting for at least one desk; wherein the at least one desk is height-adjustable and may be removable. In practical terms a user can stand or sit at the desk by moving it to the appropriate height.

The bed, rack and modular components for vehicles system 100 also provides that the first portion of the framing 110 is able to form at least one bench (for sitting) able to support a weight of at least 500 pounds. The van may be retrofitted with a bench on each side if desired and the boxed construction allows for items to be stored under for maximum space efficiency. The framing 110 provides a (general) mounting means by which appliance(s) are able to be removably affixed to the interior of the vehicle.

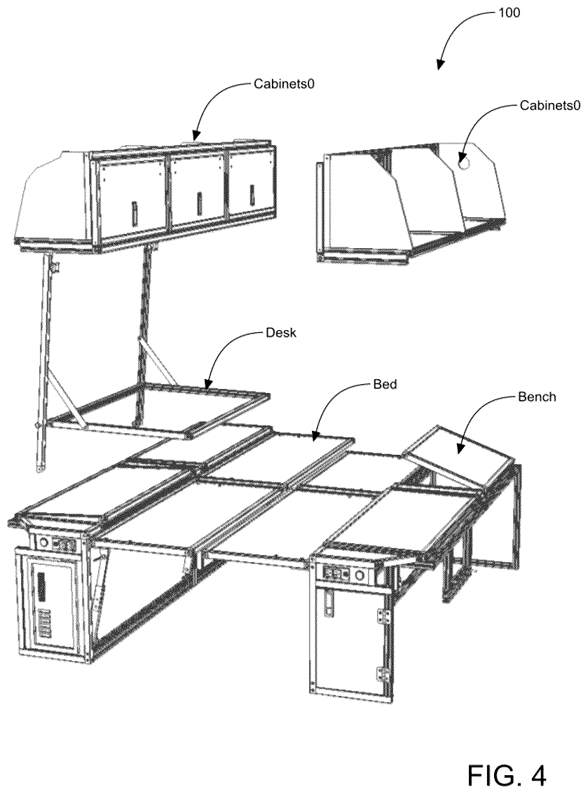

Referring now to FIG. 4, showing the bed, rack and modular components for vehicles system 100. The bed, rack and modular components for vehicles system 100 may be sold as kit(s) comprising the following parts (according to user need and preference): the framing 110 comprising the first-portion of the framing 110 comprising the floor-section 120, the right-wall-section 130, the left-wall section 140 and the roof-section 150, and the second-portion of the framing 110 (any add on to the structure of the first-portion of framing 110), the surface members wood or other material cut to form the bed, the desk, the shelves and the doors, the plurality of fasteners, the hydraulic rams, the electrical harnesses and components, the insulation, and a set of installation instructions and video with information as to potential modular designs. The kit has instructions such that functional relationships are detailed in relation to the structure of the invention (such that the invention can be used, maintained, or the like in a preferred manner). The bed, rack and modular components for vehicles system 110 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

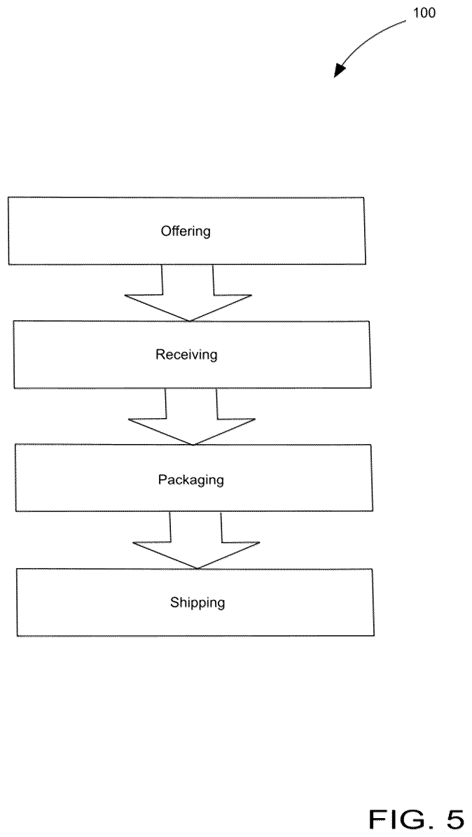

Referring now to FIG. 5, a flowchart illustrating a method of use for the bed, rack and modular components for vehicles system 100 according to an embodiment of the present invention of FIGS. 1-4.

A method of monetizing a bed, rack and modular components for vehicles system preferably comprises the steps of: offering a modular the bed, rack and modular components for vehicles system for purchase by at least one consumer, the at least one consumer able to custom select a user-defined package, receiving payment for the user-defined package, packaging the user defined package according to a pre-determined shipping rate for shipping, and shipping the user defined package to the at least one consumer. The method may further comprise the step of licensing the installation to an installation-entity to install the bed, rack and modular components for vehicles system for the at least one consumer. Some of the components and vehicle may be controlled remotely via software applications manipulated on an electronic device such as a smart phone. It should be noted that the licensing step is an optional step and may not be implemented in all cases. Optional steps of the method are illustrated using dotted lines in FIG. 5 so as to distinguish them from the other steps of the method.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bed, rack and modular components for vehicles system comprising:
framing;
surface members;
a plurality of fasteners;
electrical harnesses and components; and
insulation;
wherein a first-portion of said framing is affixed to an interior of a vehicle via said plurality of fasteners and is in mechanical communication with a second-portion of said framing which is affixed in combination with said surface members into functional modular components that are able to be modularly oriented as per user-preference;
wherein said second-portion of said framing is able to be manipulated in relation to said first-portion of said framing at will;
wherein said electrical harnesses and said components are in electrical communication with said vehicle to service electrical devices in said interior of said vehicle;
wherein said insulation is a sound-deadener; and
wherein said universalized mounting structure for vehicles system in functional combination is able to be installed in said vehicle for installation.

2. The bed, rack and modular components for vehicles system of claim 1 further comprising hydraulic rams.

3. The bed, rack and modular components for vehicles system of claim 2 wherein said hydraulic rams allow tables to be in communication with said first-portion of said framing.

4. The bed, rack and modular components for vehicles system of claim 3 wherein said tables are able to be raised and alternately lowered in relation to said first-portion of said framing.

5. The bed, rack and modular components for vehicles system of claim 1 wherein a table is able to be lowered in relation to a roof wall of said first-portion of said framing.

6. The bed, rack and modular components for vehicles system of claim 1 wherein said first-portion of said framing comprises a floor-section, a right-wall-section, a left-wall-section and a roof section, all designed to be installed respectively.

7. The bed, rack and modular components for vehicles system of claim 6 wherein said floor-section, said right-wall-section, said left-wall-section and said roof-section are installable within and to said interior of said vehicle.

8. The bed, rack and modular components for vehicles system of claim 1 wherein one of said functional modular components is a bed comprising exactly one said bed, said bed able to be removed and items able to be stored under said bed.

9. The bed, rack and modular components for vehicles system of claim 8 wherein said bed comprises two or more of said bed, a top-bed oriented on a plane above a bottom-bed.

10. The bed, rack and modular components for vehicles system of claim 1 wherein said functional modular components comprise racks which are able to provide mounting for shelves.

11. The bed, rack and modular components for vehicles system of claim 10 wherein said shelves are open.

12. The bed, rack and modular components for vehicles system of claim 10 wherein said shelves are able to be closed via doors on hinges mounted thereon, and alternately opened via rotating said doors.

13. The bed, rack and modular components for vehicles system of claim 10 wherein said racks are able to provide mounting for at least one desk.

14. The bed, rack and modular components for vehicles system of claim 1 wherein said at least one desk is height-adjustable.

15. The bed, rack and modular components for vehicles system of claim 1 wherein said first-portion of said framing forms at least one bench able to support a weight of at least 500 pounds.

16. The bed, rack and modular components for vehicles system of claim 1 wherein said framing provides a mounting means by which appliance(s) are able to be removably affixed to said interior of said vehicle.

17. A bed, rack and modular components for vehicles system comprising:
framing;
surface members comprising wood;
a plurality of fasteners;
hydraulic rams;
electrical harnesses and components; and
insulation;
wherein a first-portion of said framing is affixed to an interior of a vehicle via said plurality of fasteners and is in mechanical communication with a second-portion of said framing which is affixed in combination with said surface members into a bed, racks, cabinets, and benches that are able to be modularly oriented as per user-preference;
wherein said second-portion of said framing is able to be manipulated in relation to said first-portion of said framing at will;
wherein said first-portion of said framing comprises a floor-section, a right-wall-section, a left-wall section and a roof-section, all designed to be installed respectively;
wherein said floor-section, said right-wall-section, said left-wall-section and said roof-section are installable within and to said interior of said vehicle;
wherein said hydraulic rams allow tables to be in communication with said first-portion of said framing;
wherein said tables are able to be raised and alternately lowered in relation to said first portion of said framing;
wherein said table is able to be lowered in relation to a roof wall of said first-portion of said framing;
wherein said bed comprises exactly one said bed, said bed able to be removed and items able to be stored under said bed;
wherein said racks are able to provide mounting for shelves;
wherein said shelves are able to be closed via doors on hinges mounted thereon, and alternately opened via rotating said doors;
wherein said racks are able to provide mounting for at least one desk;
wherein said at least one desk is height-adjustable;
wherein said first-portion of said framing forms at least one bench able to support a weight of at least 500 pounds;
wherein said framing provides a mounting means by which appliance are able to be removably affixed to said interior of said vehicle;
wherein said electrical harnesses and said components are in electrical communication with said vehicle to service electrical devices in said interior of said vehicle;
wherein said insulation is a sound-deadener; and
wherein said universalized mounting structure for vehicles system in functional combination is able to be shipped via flat pack and ship and once received installed in said vehicle.

18. The bed, rack and modular components for vehicles system of claim 17 further comprising
a kit including:
said framing comprising said first-portion of said framing comprising said floor section, said right-wall-section, said left-wall-section and said roof-section, and said second-portion of said framing;
said surface members cut to form said bed, said desk, said shelves and said doors;
said plurality of fasteners;
said hydraulic rams;
said electrical harnesses and components;
said insulation; and
a set of installation instructions and video with information as to potential modular designs, all shippable as said kit via said flat pack and ship.

19. A method of monetizing a bed, rack and modular components for vehicles system comprising the steps of:
offering a modular said bed, rack and modular components for vehicles system for purchase by at least one consumer, said at least one consumer able to custom select a user-defined package;
receiving payment for said user-defined package;
packaging said user-defined package according to a pre-determined shipping rate for shipping; and
shipping said user-defined package to said at least one consumer via flat pack and ship.

20. The method of claim 19 further comprising the step of licensing installation to an installation entity to install said bed, rack and modular components for vehicles system for said at least one consumer.
